(19) United States
(12) Patent Application Publication
(10) Pub. No.: US 2026/0104618 A1
(43) Pub. Date: Apr. 16, 2026

(54) PRODUCTION METHOD FOR NANOPARTICLES USED FOR LIGHT VALVES OF DIFFERENT COLORS, LIGHT VALVES OF DIFFERENT COLORS AND APPLICATION THEREOF

(71) Applicant: SMART LIQUID CRYSTAL TECHNOLOGIES CO., LTD., Suzhou, Jiangsu (CN)

(72) Inventors: Wei ZHU, Suzhou (CN); Jiayue NIU, Suzhou (CN); Jiabin WANG, Suzhou (CN); Yichen ZHANG, Suzhou (CN); Yao WANG, Suzhou (CN)

(73) Assignee: SMART LIQUID CRYSTAL TECHNOLOGIES CO., LTD., Suzhou, Jiangsu (CN)

(21) Appl. No.: 19/116,862

(22) PCT Filed: Sep. 26, 2023
(86) PCT No.: PCT/CN2023/121651

§ 371 Date: Mar. 28, 2025

(30) Foreign Application Priority Data
Oct. 14, 2022 (CN) 202211256402.9

(51) Int. Cl. G02F 1/17; C08B 15/06; C09B 57/00; C09B 67/22; C09B 67/46

(52) U.S. Cl. CPC G02F 1/172; C08B 15/06; C09B 57/00; C09B 67/0034; C09B 67/0084

(57) ABSTRACT

The present invention relates to production method for nanoparticles used for light valves of different colors, light valves of different colors and application thereof. The light values comprise: a first transparent substrate, a first transparent conductive layer, a light modulating layer, a second transparent conductive layer and a second transparent substrate, the light modulating layer comprises a dispersion liquid and a nanoparticle dispersed-phase dispersed in the dispersion liquid; The tinted states of the light valve are displayed as multiple different colors in the visible spectral region, the bright state is colorless and transparent, and the multiple different colors of the light valve are realized by mixing nanoparticles of same or different color to form a mixture in the form of the nanoparticle dispersed-phase.

This application claims the priority to patent application CN202211256402.9 entitled LIGHT VALVES OF DIFFERENT COLORS AND APPLICATION THEREOF filed on Oct. 14, 2022, and all its contents are incorporated in this application by reference.

### TECHNICAL FIELD

The invention relates to electro-optic devices, and in particular, to light valves of different colors and application thereof. More particularly, the present invention relates to production method for three optical primary colored nanoparticles for achieving a variety of light valves with different colors.

### BACKGROUND

The light valve of a suspended particle device (SPD) is based on the variation of orientation of rod-shaped particles upon the application of an external electric field, which changes the optical absorption, scattering and reflection of composites, and thereby resulting in the transmission of the photon flux. Consequently, all of the optical anisotropy, dielectricity and relaxation time of the nanoparticles (NPs) determine the properties of the suspended particle light valve. Based on the above characteristics, SPD technology can not only applied to traditional windows to gradually replace the curtains and shutters, but can also to be applied to other fields, such as automotive sunroof, visor, goggles, curtain wall, VR glasses and displays, and the like.

Disappointingly, the current reported SPD light valve can only appear blue or white at tinted state (Solar Energy Materials & Solar Cells 2015, 143, 613-622; Optical Materials, 2015, 46, 418-422; Nanotechnology, 2014, 25, 415703). This is mainly due to the size effect and intrinsic absorption of suspended particles in the light valve. The defect of a single hue makes the SPD light valve limited in practical applications, greatly narrowing the scope of commercial applications. Patent CN111679455A discloses a method employing dye molecules into the suspension to change the colorfulness of the device. The scheme is feasible to some extent. However, due to the defects of small organic molecules of dyes in weather resistance, light stability and environmental protection and the like, the practicality is poor. Patent CN207440490U discloses a dimming technology that achieves different colors of PDLC by adding dyes. To a certain extent, the scheme can effectively obtain colored devices. However, like the patent CN111679455A, the defects of the dye molecules are still inevitable.

Accordingly, there is a need to provide a light valve with optional color and stable performance, which can improve the problem of SPD with single color.

### SUMMARY

This invention aims at providing a method to obtain light valves of different colors. By adjusting the types of suspended particles in the system, the tinted state of SPD is displayed as a variety of colors in the visible spectrum, meeting above-described needs.

The embodiment and purpose of the present application are hereinafter described and illustrated, given by examples combined with systems, tools, and methods. These examples are just exemplary and explanatory rather than limitation. In various embodiments, the present invention has met one or more market requirements, while other embodiments are directed to other improvements.

The primary objective of the present application is to provide light valves of different colors, wherein light valves have multiple states including tinted states that can be displayed in the visible spectrum, and a colorless and transparent bright state.

Another object of the present application is to provide light valves of different colors, wherein the different colors are realized through the mixture of one or more optical primary color nanoparticles.

Another object of the present application is to provide production method for the optical primary color nanoparticles. The optical primary color nanoparticles obtained by this method can respectively present a respective color of three RGB.

Another object of the present application is to provide different applications of the above light valves in various fields.

For the purposes of the application, the application provides light valves of different colors, the light valves comprise: a first transparent substrate, a first transparent conductive layer, a light modulating layer, a second transparent conductive layer, and a second transparent substrate disposed in sequence, the light modulating layer comprises a dispersion liquid and a nanoparticle dispersed-phase dispersed in the dispersion liquid. The tinted states of the light valve are displayed as different colors in the visible spectral region, the bright states are colorless and transparent, and the different colors of the light valve are realized by mixing nanoparticles of same or different color to form a mixture in the form of the nanoparticle dispersed-phase.

As a further improvement of the application, the shape of the nanoparticles is at least one of rod-shaped, linear, sheet-shaped, disk-shaped, taper-shaped or irregular granule-shaped.

As a further improvement of the application, the nanoparticle has a ratio of axial length to diameter no less than 4.

As a further improvement of the application, the nanoparticles can be directionally aligned with exposure to an external electric field.

As a further improvement of the application, the nanoparticles are selected from one or more of three optical primary color nanoparticles mixed in a variety of ratios, and the three optical primary color nanoparticles are nanoparticles that display blue, red, and green, respectively.

For the purposes of the application, the application provides a production method for nanoparticles used for the light valves of different colors described above, the nanoparticles are optical primary color nanoparticle, the optical primary color nanoparticles are obtained by reacting nitrogen-containing heterocyclic carboxylic acid, halide and/or halogen and phosphorus-containing compounds in a solvent.

As a further improvement of the application, the said reaction further comprises the step of adding an acyl halide.

Wherein, the preparation method for nanoparticles displaying blue including the steps:
S1. dissolving metal halide, a halogen simple substance, a cellulose and phosphorus-containing compound into an ester to form a mixed solution;
S2. adding 2,5-pyrazinedicarboxylic acid and an alcohol into the mixed solution generated in said step S1, then heating the mixture to react, waiting until the reaction is completed, centrifuging the reaction solution, thus obtaining said nanoparticles displaying blue.

As a further improvement of the application, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

As a further improvement of the application, wherein the ester is at least one of isoamyl acetate, ethyl acetate, propyl acetate and butyl acetate.

As a further improvement of the application, the nanoparticles displaying blue have a length of 400-1500 nm and a width of 40-200 nm.

Wherein, the preparation method for nanoparticles displaying green including the steps:
S1. dissolving metal halide, a halogen simple substance, a cellulose and phosphorus-containing compound into the ester to form a mixed solution;
S2. adding 2,3-pyrazinedicarboxylic acid and an alcohol into the mixed solution generated in said step S1, heating the mixture to react, waiting until the reaction is completed, centrifuging the reaction solution, thus obtaining said nanoparticles displaying green.

As a further improvement of the application, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,3-pyrazinedicarboxylic acid in said step S2 is 1%-20%.

As a further improvement of the application, wherein the ester is at least one of isoamyl acetate, ethyl acetate, propyl acetate and butyl acetate.

As a further improvement of the application, the nanoparticles displaying green have a length of 400-1500 nm and a width of 20-300 nm.

Wherein, the preparation method for nanoparticles displaying blue including the steps:
S1. dissolving metal halide, a halogen simple substance, a cellulose and phosphorus-containing compound into the ester to form a mixed solution;
S2. adding 2,5-pyrazinedicarboxylic acid and an alcohol into the mixed solution generated in said step S1, and then adding an acyl halide, heating the mixture to react, waiting until the reaction is completed, centrifuging the reaction solution, thus obtaining said nanoparticles displaying red.

As a further improvement of the application, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

As a further improvement of the application, wherein the ester is at least one of isoamyl acetate, ethyl acetate, propyl acetate and butyl acetate.

As a further improvement of the application, wherein the acyl halide is selected from any one of acyl fluoride, acyl chloride, acyl bromide, and acyl iodide.

As a further improvement of the application, wherein the acyl chloride is selected from acyl chloride having from 1 to 18 carbon atoms.

As a further improvement of the application, wherein the acyl chloride is any one of stearoyl chloride, n-valeryl chloride, and dodecanoyl chloride.

As a further improvement of the application, the nanoparticles displaying red has a length of 400-4000 nm and a width of 40-200 nm.

This application also provides the use of the light valves of different colors described above in the field of curtain wall, automotive glass, indoor decorations or displays.

The present application discloses the processes for making the three optical primary color nanoparticles, by compounding three optical primary color nanoparticles in different proportions, the color regulation and control of the nanoparticles are realized, which effectively overcomes the shortcoming in the prior art that the tinted state of the SPD light valve is blue tone and the light valve is monotonous in color, additionally meet the demands of a variety of colors of the tinted state of the light valve, thereby obtaining a relatively good technical effect, and having good application prospects.

### BRIEF DESCRIPTION OF THE DRAWINGS

FIG. 1 is a schematic view of the light valve of different colors in the absence (a) and presence (b) of the applied voltage, which is prepared according to the present application.

FIG. 2 is the SEM photographs of the nanoparticles displaying blue (I);

FIG. 3 is the SEM photographs of the nanoparticles displaying red (III);

FIG. 4 is the SEM photographs of the nanoparticles displaying sky-blue (IV);

FIG. 5 is the SEM photographs of the nanoparticles displaying purple (V);

FIG. 6 is graph illustrating a voltage-transmittance curve of the light valves of different colors prepared by nanoparticles obtained by some embodiments;

FIG. 7 is graph illustrating a wave number-transmittance curve of the light valve of different colors prepared nanoparticles displaying red (III).

### DETAILED DESCRIPTION OF EMBODIMENTS

In order to make the objects, technical solutions, and advantages of the present application more precise, the technical solutions of the present application will be clearly and completely described in the following section concerning the embodiments of the present application. It is apparent that the described embodiments are a part of the embodiments of the present application rather than all of the embodiments. All other embodiments obtained by those skilled in the art based on the technical solutions and embodiments provided by the present application and without the creative work are all within the scope of the present application.

As used herein, the term “a,” “an,” “the” and similar terms used in the context of the present invention (especially in the context of the claims) are to be construed to cover both the singular and plural unless otherwise indicated herein or clearly contradicted by the context.

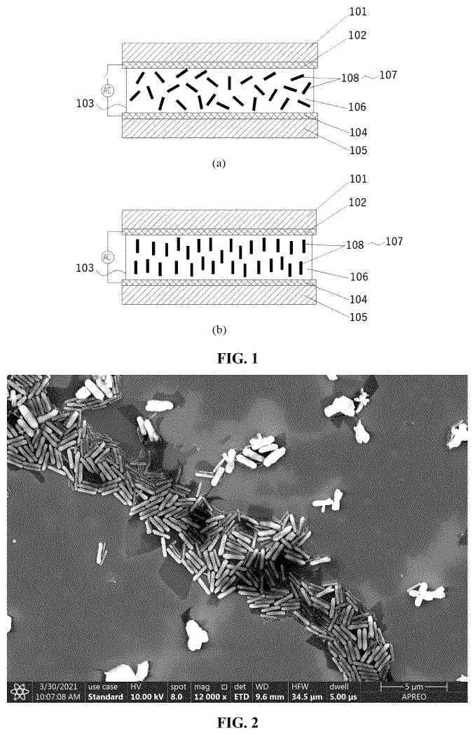

Referring to FIG. 1, the present invention relates to light valves of different colors which comprise: a first transparent substrate 101, a first transparent conductive layer 102, a light modulating layer 103, a second transparent conductive layer 104 and a second transparent substrate 105 disposed in sequence, the light modulating layer 103 comprises a dispersion liquid 106 and a nanoparticle dispersed-phase 107 dispersed in the dispersion liquid 106; The tinted states of the light valve are displayed as multiple different colors in the visible spectral region, the bright state is colorless and transparent, and the multiple different colors of the light valve are realized by mixing nanoparticles of same or different color to form a mixture in the form of the nanoparticle dispersed-phase.

As a preferred embodiment, the shape of the nanoparticles is at least one of rod-shaped, linear, sheet-shaped, disk-shaped, taper-shaped or irregular granule-shaped. As a preferred embodiment, the nanoparticle has a ratio of axial length to diameter no less than 4. As a preferred embodiment, the nanoparticles can be directionally aligned with exposure to an external electric field.

As a preferred embodiment, the nanoparticles are selected from one or more of three optical primary color nanoparticles mixed in a variety of ratios, and the three optical primary color nanoparticles are nanoparticles that display blue, red, and green, respectively.

Herein, “one or more of three optical primary color nanoparticles mixed in a variety of ratios” refer to the process of mixing at least two kinds of nanoparticles at different mass ratios which display different colors; thereby enabling the display a plurality of colors between the different colors described above.

The above optical primary color nanoparticles are obtained by reacting nitrogen-containing heterocyclic carboxylic acid, halide and/or halogen, and phosphorus-containing compounds in a solvent, as a preferred embodiment, the said reaction further comprises the step of adding an acyl halide.

The principle of color implementation of optical primary color nanoparticles is based on the fact that the colors of the optical primary color nanoparticles is realized by changing the arrangement structure of the halide ions and the morphology of nanoparticles to modify their absorption of light, more particularly, the colors of optical primary color nanoparticles are realized by changing the types of nitrogen-containing heterocyclic carboxylic acid or by adding acyl halides.

In the application, the preparation method for nanoparticles displaying blue including the steps:
S1. dissolving metal halide, a halogen simple substance, a cellulose and phosphorus-containing compound into the ester to form a mixed solution;
S2. adding 2,5-pyrazinedicarboxylic acid and an alcohol into the mixed solution generated in said step S1, heating the mixture to react, waiting until the reaction is completed, centrifuging the reaction solution, thus obtaining said nanoparticles displaying blue.

As a preferred embodiment, the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

As a preferred embodiment, the ester is at least one of isoamyl acetate, ethyl acetate, propyl acetate and butyl acetate. As a preferred embodiment, the nanoparticles displaying blue have a length of 400-1500 nm and a width of 40-200 nm.

In the application, the preparation method for nanoparticles displaying green including the steps:
S1. dissolving metal halide, a halogen simple substance, a cellulose and phosphorus-containing compound into the ester to form a mixed solution;
S2. adding 2,3-pyrazinedicarboxylic acid and an alcohol into the mixed solution generated in said step S1, heating the mixture to react, waiting until the reaction is completed, centrifuging the reaction solution, thus obtaining said nanoparticles displaying green.

As a preferred embodiment, the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,3-pyrazinedicarboxylic acid in said step S2 is 1%-20%.

As a preferred embodiment, the ester is at least one of isoamyl acetate, ethyl acetate, propyl acetate and butyl acetate. As a preferred embodiment, the nanoparticles displaying green have a length of 400-1500 nm and a width of 20-300 nm.

In the application, the preparation method for nanoparticles displaying blue including the steps:
S1. dissolving metal halide, a halogen simple substance, a cellulose and phosphorus-containing compound into the ester to form a mixed solution;
S2. adding 2,5-pyrazinedicarboxylic acid and an alcohol into the mixed solution generated in said step S1, and then adding an acyl halide, heating the mixture to react, waiting until the reaction is completed, centrifuging the reaction solution, thus obtaining said nanoparticles displaying red.

As a preferred embodiment, the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

As a preferred embodiment, the ester is at least one of isoamyl acetate, ethyl acetate, propyl acetate and butyl acetate. In a preferred embodiment, the acyl halide is selected from any one of acyl fluoride, acyl chloride, acyl bromide, and acyl iodide. As a further preferred embodiment, the acyl halide is selected from acyl halide having from 1 to 18 carbon atoms. As an even further preferred embodiment, the acyl halide is any one of stearoyl chloride, n-valeryl chloride, and dodecanoyl chloride. Such compounds can be used to create surface modification and alkane segment are grafted onto the surface of the materials, and the hydrogen chloride generated during the reaction can not only change the pH of the reaction solution and weaken the adsorption force of the N atoms in the heterocyclic organic component in the material on the halogen ions, but also form a chlorine-containing halide ion with halogen molecule e.g. I₂Cl⁻, which alters the valence bond structure of the halogen ion itself and ends up changing the arrangement structure of the halide ions in the material structure, and in turn affects the absorption of light by the material.

As a preferred embodiment, the nanoparticles displaying red has a length of 400-4000 nm and a width of 40-200 nm.

In the present application, as the ratio of axial length to diameter of the anisometric (e.g. rod-shaped, linear, taper-shaped) nanoparticles with optically anisotropicdispersed in the liquid medium is greater than 4 and the volume concentration is higher than that of the liquid crystal transition concentration thereof, thereby forming a corresponding lyotropic liquid crystal system. When an AC electric field is applied to the system, the suspended nanoparticles are polarized to impel their long-axis direction to rotate in the direction of the electric field, and finally an ordered arrangement that the long axes thereof entirely align along the direction of the electric field can be formed. At this time, the light blocking in the above ordered arrangement structure is minimum and the light valve is in a bright state. When the electric field is withdrawn, the polarizing effects are lost and the suspended nanoparticles will show a disordered arrangement structure with application of Brownian motion, and that the nanoparticles with different optically anisotropic may block light of different wavelength bands through absorption, scattering and the like, thereby displaying a corresponding complimentary color. According to the principle of optical color matching, either color in color circle can be obtained by mixing two neighboring monochromic light or even secondary neighboring light, and so that when different optical color nano materials are well mixed, the prepared light modulating layer can block and super-positioning light photon of light waveform bands depending on the proportion of the mixed nanoparticles appears as the corresponding complimentary color, so that tinted state of a plurality of different colors are realized.

In order to further achieve the object of the present application, this application also provides the use of the light valves of different colors described above in the field of curtain wall, automotive glass, indoor decorations or displays.

The light valves of different colors in this application will be described in detail below with reference to specific embodiments. Subsequently, tests on the performance of the light valves prepared by nanoparticles of different colors were conducted.

### Embodiment 1: Preparation of Optical Primary Color Nanoparticles

In order to prepare the light valve whose tinted states are displayed as different colors in the visible spectral region, firstly three optical primary color nanoparticles are first prepared, i.e., nanoparticles displaying blue, nanoparticles displaying red and nanoparticles displaying green.

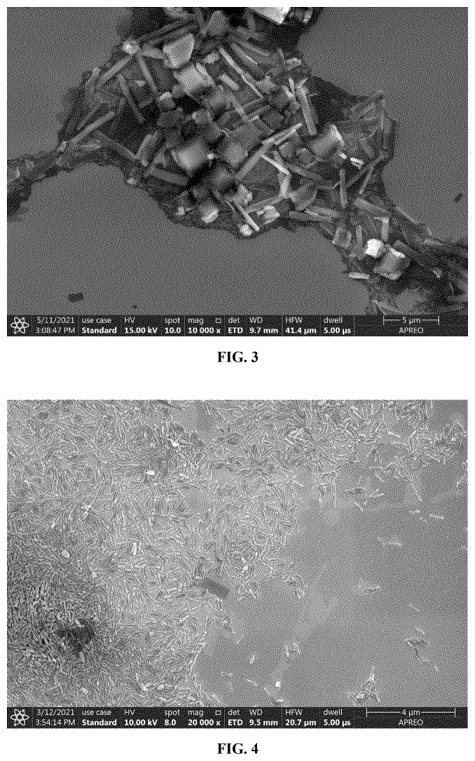

Preparation of nanoparticles displaying blue: 4.5 g of elemental iodine, 3 g of calcium iodide, 13 g of nitrocellulose and 0.35 g of calcium phosphate were dissolved in 140 mL of isoamyl acetate and fully dissolved, and then 3.5 g of 2,5-pyrazinedicarboxylic acid and 7.6 mL of methyl alcohol were added in the mixture and stirred for 30 minutes, and the resultant mixture was subjected to reaction at 45° C. for 3 hours, and then reacted under ultrasonication for 2 hours. After centrifuging and washing, the nanoparticles displaying blue (I) were obtained. As illustrated in the SEM photographs in FIG. 2, the nanoparticles have a length of roughly 1500 nm and a width of roughly 200 nm.

Preparation of nanoparticles displaying green: different from the method for preparing the nanoparticles displaying blue I, changing 2,5-pyrazinedicarboxylic acid to 2,3-pyrazinedicarboxylic acid in order to obtain the nanoparticles displaying green II, and the nanoparticles have a length of roughly 900 nm and a width of roughly 150 nm.

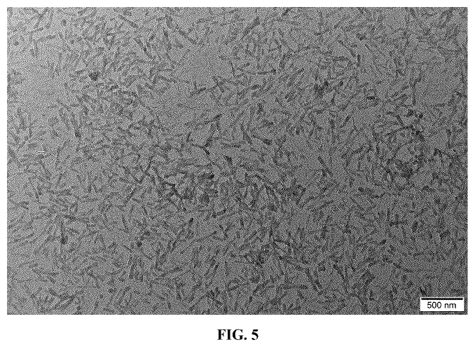

Preparation of nanoparticles displaying green: different from the method for preparing the nanoparticles displaying blue I, after the methanol is added, 1 mL of stearoyl chloride is further added to obtain the nanoparticles displaying red III. The scanning electron microscope photograph is shown in FIG. 3, and SEM analysis consequently showed that the obtained nanoparticles have a length of roughly 4000 nm and a width of roughly 200 nm.

### Embodiment 2: Preparation of Nanoparticles Displaying Multiple Colors

Preparation of nanoparticles displaying sky-blue: the nanoparticles displaying sky-blue IV were obtained by mixing “nanoparticles displaying blue I” and “nanoparticles displaying green II” in a mass ratio of 9:1,

In addition, the above-mentioned nanoparticles displaying sky-blue IV can be prepared by the process not including the procedure of adding calcium phosphate which is different from the method for preparing the nanoparticles displaying blue I. The scanning electron microscope photograph is shown in FIG. 4, and SEM analysis consequently showed that the obtained nanoparticles have a length of roughly 500 nm and a width of roughly 90 nm.

Preparation of nanoparticles displaying purple: the nanoparticles displaying purple V were obtained by mixing “nanoparticles displaying red III” and “nanoparticles displaying blue I” in a mass ratio of 3:7.

In addition, the above-mentioned nanoparticles displaying purple V can be prepared by the process of changing isoamyl acetate to a mixed solution of isoamyl acetate and cyclohexane (volume ratio is 1:1). The scanning electron microscope photograph is shown in FIG. 5, and SEM analysis consequently showed that the obtained nanoparticles have a length of roughly 200 nm and a width of roughly 40 nm.

Preparation of nanoparticles displaying yellow: the nanoparticles displaying yellow VI were obtained by mixing “nanoparticles displaying green II” and “nanoparticles displaying red III” in a mass ratio of 1:3.

Preparation of nanoparticles displaying blue-green: the nanoparticles displaying blue-green VII were obtained by mixing “nanoparticles displaying sky-blue IV” and “nanoparticles displaying green II” in a mass ratio of 1:1.

Preparation of nanoparticles displaying greyish black: the nanoparticles displaying greyish black VIII were obtained by mixing “nanoparticles displaying green II” and “nanoparticles displaying purple V” in a mass ratio of 4:5.

Preparation of nanoparticles displaying greyish purple: the nanoparticles displaying greyish purple IX were obtained by mixing “nanoparticles displaying green II” and “nanoparticles displaying purple V” in a mass ratio of 2:5.

### Embodiment 3: Fabrication of Light Valves of Different Colors

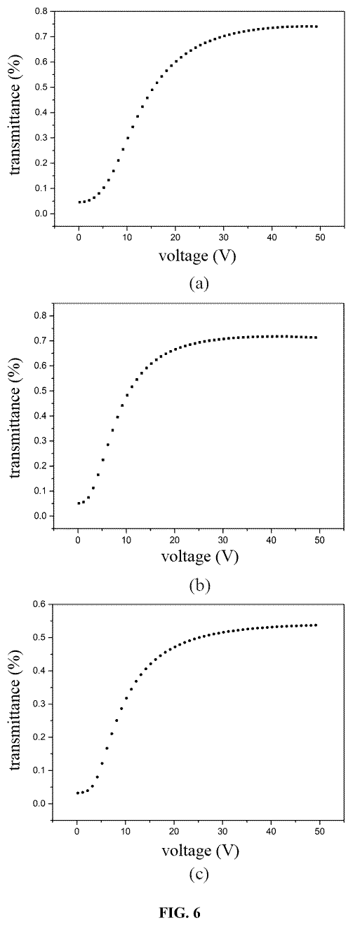

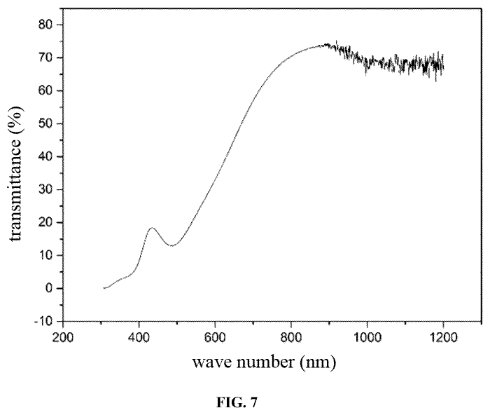

Nanoparticles I-IX (8% by mass fraction) displaying multiple colors were dispersed-phase dispersed in dispersion liquid of benzyl butyl phthalate to form the corresponding material of the light modulating layer. This material was then injected into the light modulating layer of the light value created by the first transparent substrate, the first transparent conductive layer, the light modulating layer, the second transparent conductive layer and the second transparent substrate, and eventually form the corresponding light valves of different colors. As shown in FIG. 1(a), the light valve is in a tinted state when no voltage is applied, and its light transmittance is measured. As shown in FIG. 1(b), the light valve is in a bright state when AC power supply of 100 Hz and 50 V is applied, and its light transmittance is measured. FIG. 6 is a graph illustrating the voltage-transmittance curve of the light valves prepared with nanoparticles I, IV and VI. FIG. 7 shows a wave number-transmittance curve of light valves prepared with nanoparticles displaying red III. Meanwhile, CIELAB color space coordinate data of the light valves of different colors are determined, and the results are shown in Table 1.

TABLE 1

| | | Transmittance | Transmittance | CIELAB color space | | |
|---|---|---|---|---|---|---|
| | Color of | of tinted state | of bright state | coordinate data | | |
| Device | tinted state | (%) | (%) | L | a* | b* |
| Nanoparticles I | blue | 4.8 | 72.5 | 29 | −2.04 | −2.41 |
| Nanoparticles II | green | 5.3 | 64.6 | 32 | −22.42 | 2.47 |
| Nanoparticles III | red | 4.1 | 62.7 | 26 | 29.39 | −5.47 |
| Nanoparticles IV | sky-blue | 4.9 | 69.5 | 37 | −0.33 | −22.34 |
| Nanoparticles V | purple | 7.2 | 66.9 | 35 | 0.42 | −4.47 |
| Nanoparticles VI | yellow | 3.2 | 54.8 | 36 | −8.39 | 4.27 |
| Nanoparticles VII | blue-green | 5.1 | 68.1 | 29 | −13.39 | −6.27 |
| Nanoparticles | greyish | 6.1 | 65.2 | 20 | −0.84 | −2.72 |
| VIII | black | | | | | |
| Nanoparticles IX | greyish | 6.9 | 62.9 | 25 | 0.23 | −2.47 |
| | purple | | | | | |

As shown in Table 1 and FIG. 6, the transmittance of tinted state and bright state of the light valve depends primarily on the mass concentration of the nanoparticle dispersed-phase, and the color of the light valve is determined largely by the mixing mass ratios of different nanoparticles. Furthermore, as indicated by the CIELAB color space coordinate data, the addition of blue nanoparticles shifts the light valve mixing nanoparticles of different colors to more negative b* values of color coordinates, and the addition of red nanoparticles shifts the light valve to more positive a* values of color coordinates, thereby matching the chromaticity index to color vision. Full-band spectral detection of the light valve (displayed in FIG. 7) reveals that the color presented by the light valve is mainly derived from the characteristic spectrum of the transmitted light, rather than the color seen by reflection, so that the color of the light valve obtained by mixing nanoparticles of different colors is mainly derived from the filtering of light.

In conclusion, the present application obtains the other two optical primary color nanoparticles different from nanoparticles displaying blue by employing different types of nitrogen-containing heterocyclic carboxylic acid and modifiers, and further obtains nanoparticles displaying multiple colors. The total light transmittance of the light valves prepared by nanoparticles displaying multiple colors in the present application reaches 72.5%, demonstrating enhanced optical control compared to prior art. This method not only addresses the limitation of monochromatic blue states in existing light valves but also expands their application scope.

It should be understood that although the examples described above provided certain specific embodiments in accordance with the present invention, those embodiments are exemplary, that such a description manner is only for the sake of clarity, that those skilled in the art should take the description as an integral part, and that the technical solutions in the embodiments may be suitably combined to form other embodiments understandable by those skilled in the art.

The detailed descriptions set forth above are merely specific illustrations of feasible embodiments of the present invention and are not intended to limit the scope of protection of the present invention. All equivalent embodiments or modifications that do not depart from the art spirit of the present invention should fall within the scope of protection of the present invention.

1-23. (canceled)

24. Light valves of different colors, wherein the light valves comprise: a first transparent substrate, a first transparent conductive layer, a light modulating layer, a second transparent conductive layer and a second transparent substrate disposed in sequence, the light modulating layer comprises a dispersion liquid and a nanoparticle dispersed-phase dispersed in the dispersion liquid; The tinted states of the light valves are displayed as multiple different colors in the visible spectral region, the bright states are colorless and transparent, and the multiple different colors of the light valve are realized by mixing nanoparticles of same or different color to form a mixture in the form of the nanoparticle dispersed-phase.

25. The light valves of different colors according to claim 24, wherein the shape of the nanoparticles is at least one of rod-shaped, linear, sheet-shaped, disk-shaped, taper-shaped or irregular granule-shaped.

26. The light valves of different colors according to claim 24, wherein the nanoparticle has a ratio of axial length to diameter no less than 4, or the nanoparticles can be directionally aligned with exposure to an electric field.

27. The light valves of different colors according to claim 24, wherein the nanoparticles are selected from one or more of three optical primary color nanoparticles mixed in a variety of ratios, and the three optical primary color nanoparticles are nanoparticles that display blue, red, and green, respectively.

28. A production method for nanoparticles used for the light valves of different colors according to claim 24, wherein the nanoparticles are optical primary color nanoparticle, the optical primary color nanoparticles are obtained by reacting nitrogen-containing heterocyclic carboxylic acid, halide and/or halogen and phosphorus-containing compounds in a solvent.

29. The production method for nanoparticles according to claim 28, wherein the said reaction further comprises the step of adding an acyl halide.

30. The production method for nanoparticles according to claim 28, wherein the preparation method for nanoparticles displaying blue including the steps:
S1. dissolving metal halide, a halogen simple substance, a cellulose and phosphorus-containing compound into the ester to form a mixed solution;
S2. adding 2,5-pyrazinedicarboxylic acid and an alcohol into the mixed solution generated in said step S1, heating the mixture to react, waiting until the reaction is completed, centrifuging the reaction solution, thus obtaining said nanoparticles displaying blue.

31. The production method for nanoparticles according to claim 30, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

32. The production method for nanoparticles according to claim 30, wherein the ester is at least one of isoamyl acetate, ethyl acetate, propyl acetate and butyl acetate.

33. The production method for nanoparticles according to claim 30, wherein the preparation method for nanoparticles displaying green including the steps:
S1. dissolving metal halide, a halogen simple substance, a cellulose and phosphorus-containing compound into the ester to form a mixed solution;
S2. adding 2,3-pyrazinedicarboxylic acid and an alcohol into the mixed solution generated in said step S1, heating the mixture to react, waiting until the reaction is completed, centrifuging the reaction solution, thus obtaining said nanoparticles displaying green.

34. The production method for nanoparticles according to claim 33, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,3-pyrazinedicarboxylic acid in said step S2 is 1%-20%.

35. The production method for nanoparticles according to claim 33, wherein the ester is at least one of isoamyl acetate, ethyl acetate, propyl acetate and butyl acetate.

36. The production method for nanoparticles according to claim 30, wherein the preparation method for nanoparticles displaying blue including the steps:
S1. dissolving metal halide, a halogen simple substance, a cellulose and phosphorus-containing compound into the ester to form a mixed solution;
S2. adding 2,5-pyrazinedicarboxylic acid and an alcohol into the mixed solution generated in said step S1, and then adding an acyl halide, heating the mixture to react, waiting until the reaction is completed, centrifuging the reaction solution, thus obtaining said nanoparticles displaying red.

37. The production method for nanoparticles according to claim 36, wherein the mass ratio of the metal halide to the halogen simple substance in said step S1 is 1:0.1-1:10, the mass ratio of the metal halide to the cellulose in said step S1 is 1:0.1-1:10, the mass ratio of the metal halide to the phosphorus-containing compound in said step S1 is 1:10-100:1, and the mass fraction of 2,5-pyrazinedicarboxylic acid in said step S2 is 1%-20%.

38. The production method for nanoparticles according to claim 36, wherein the ester is at least one of isoamyl acetate, ethyl acetate, propyl acetate and butyl acetate.

39. The production method for nanoparticles according to claim 36, wherein the acyl halide is selected from any one of acyl fluoride, acyl chloride, acyl bromide, and acyl iodide.

40. The production method for nanoparticles according to claim 39, wherein the acyl chloride is selected from acyl chloride having from 1 to 18 carbon atoms.

41. The production method for nanoparticles according to claim 40, wherein the acyl chloride is any one of stearoyl chloride, n-valeryl chloride, and dodecanoyl chloride.

42. The production method for nanoparticles according to claim 28, wherein the three optical primary color nanoparticles are nanoparticles that display blue, red, and green, respectively;
the nanoparticles displaying blue have a length of 400-1500 nm and a width of 40-200 nm;
or the nanoparticles displaying green have a length of 400-1500 nm and a width of 20-300 nm;
or the nanoparticles displaying red has a length of 400-4000 nm and a width of 40-200 nm.

43. The use of the light valves of different colors according to claim 24 in the field of curtain wall, automotive glass, indoor decorations or displays.
